(19) United States
(12) Patent Application Publication
(10) Pub. No.: US 2025/0324194 A1
(43) Pub. Date: Oct. 16, 2025

(54) VIBRATION INSULATION SUSPENSION FOR EAR WEARABLE AUDIO COMPONENTS

(71) Applicant: Starkey Laboratories, Inc., Eden Prairie, MN (US)

(72) Inventors: Viktor Klymko, Minneapolis, MN (US); Jay Stewart, Eden Prairie, MN (US); Sidney A. Higgins, Maple Grove, MN (US)

(21) Appl. No.: 19/052,775

(22) Filed: Feb. 13, 2025

Related U.S. Application Data
(60) Provisional application No. 63/561,210, filed on Mar. 4, 2024.

(51) Int. Cl. H04R 1/28; H04R 1/10

(52) U.S. Cl. CPC H04R 1/2896; H04R 1/1016; H04R 1/1075

(57) ABSTRACT

Embodiments herein relate to vibration insulation suspension for in-ear audio components. In an embodiment, an ear-wearable device is included having a shell defining a shell cavity and a shell opening. The ear-wearable device can include a receiver disposed within the shell cavity and an acoustic tube wherein the acoustic tube is configured to connect the receiver to the shell opening such that sounds generated by the receiver exit the ear-wearable device through the shell opening. The acoustic tube has a stem having a first end connected to the receiver and a second end and a flange connected to the second end. The flange is configured to contact the shell opening such that the stem does not contact the shell. The flange includes a deformable material such that vibrations of the receiver result in deformations of at least a portion of the flange. Other embodiments are also included herein.

This application claims the benefit of U.S. Provisional Application No. 63/561,210, filed Mar. 4, 2024, the content of which is incorporated herein by reference in its entirety.

### FIELD

Embodiments herein relate to in-ear audio components and more particularly to vibration insulation suspension for in-ear audio components.

### BACKGROUND

Modern ear-wearable devices include hearing aids, which are electronic instruments worn in or around the ear that compensate for hearing losses by producing or optionally amplifying sound. Ear-wearable devices typically include an enclosure or housing with one or more openings for a microphone that senses sound, hearing assistance device electronics including processing electronics, and a speaker or receiver to play sound for the wearer. In some scenarios, the ear-wearable devices can suffer gain limitations due to mechanical vibrations. For instance, vibrations generated by the receiver may be picked up by the microphone, limiting the device output.

### SUMMARY

In a first aspect, an ear-wearable device can be included having a shell configured to fit within an ear of a user. The shell can be included having a shell cavity and a shell opening to the shell cavity. The ear-wearable device can include a receiver disposed within the shell cavity and an acoustic tube, wherein the acoustic tube can be configured to connect the receiver to the shell opening such that sounds generated by the receiver exit the ear-wearable device through the shell opening. The acoustic tube can be included having a stem. The stem can be included having a first end, wherein the first end can be connected to the receiver and a second end. The acoustic tube can include a flange connected to the second end. The flange can be configured to contact the shell opening along an inner flange surface such that the stem does not contact the shell. The flange includes a deformable material such that vibrations of the receiver result in deformations of at least a portion of the flange.

In a second aspect, in addition to one or more of the preceding or following aspects, or in the alternative to some aspects, the deformations of the flange reduce transmission of the vibrations from the receiver to the shell.

In a third aspect, in addition to one or more of the preceding or following aspects, or in the alternative to some aspects, the deformable material can have a modulus of elasticity can be greater than or equal to 5 megapascals.

In a fourth aspect, in addition to one or more of the preceding or following aspects, or in the alternative to some aspects, the deformable material includes a fluoroelastomeric material.

In a fifth aspect, in addition to one or more of the preceding or following aspects, or in the alternative to some aspects, the shell opening includes a ledge, and the flange can be configured to be positioned on the ledge along the inner flange surface.

In a sixth aspect, in addition to one or more of the preceding or following aspects, or in the alternative to some aspects, the inner flange surface can be joined to the ledge using an adhesive.

In a seventh aspect, in addition to one or more of the preceding or following aspects, or in the alternative to some aspects, the flange can further include a supported portion. The supported portion can be in contact with the ledge along the inner flange surface, and a non-supported portion, wherein the non-supported portion can be not in contact with the ledge along the inner flange surface.

In an eighth aspect, in addition to one or more of the preceding or following aspects, or in the alternative to some aspects, the vibrations of the receiver result in deformations of the non-supported portion.

In a ninth aspect, in addition to one or more of the preceding or following aspects, or in the alternative to some aspects, the flange can be integral with the stem.

In a tenth aspect, in addition to one or more of the preceding or following aspects, or in the alternative to some aspects, the flange and the stem can be formed separately and subsequently joined together.

In an eleventh aspect, in addition to one or more of the preceding or following aspects, or in the alternative to some aspects, further can include a structure placed over the shell opening, wherein the structure can be configured to obstruct debris from passing through the shell opening.

In a twelfth aspect, in addition to one or more of the preceding or following aspects, or in the alternative to some aspects, the structure includes one of the group consisting of a dome, a bridge, or a mesh.

In a thirteenth aspect, in addition to one or more of the preceding or following aspects, or in the alternative to some aspects, the acoustic tube can include a receiver housing configured to enclose the receiver within the shell cavity.

In a fourteenth aspect, an ear-wearable device can be included having a shell configured to fit within an ear of a user. The shell can be included having a shell cavity and a shell opening to the shell cavity. The ear-wearable device can include a receiver disposed within the shell cavity and a receiver housing configured to suspend the receiver within the shell cavity, the receiver housing defining a receiver housing outlet. An acoustic tube can be included having a stem. The stem can be included having a first end, wherein the first end can be connected to the receiver housing around the receiver housing outlet, and a second end disposed at the shell opening. The acoustic tube can include a flange connected to the second end; the flange configured to contact the shell opening along an inner flange surface such that the stem does not contact the shell. Sounds generated by the receiver can propagate from the receiver housing outlet to the shell opening via the acoustic tube. The flange includes a deformable material such that vibrations of the receiver result in deformations of at least a portion of the flange.

In a fifteenth aspect, in addition to one or more of the preceding or following aspects, or in the alternative to some aspects, the deformations of the flange reduce transmission of the vibrations from the receiver to the shell.

In a sixteenth aspect, in addition to one or more of the preceding or following aspects, or in the alternative to some aspects, the acoustic tube can be integral with the receiver housing.

In a seventeenth aspect, in addition to one or more of the preceding or following aspects, or in the alternative to some aspects, the shell opening includes a ledge and the flange can be configured can be configured to be positioned on the ledge along the inner flange surface.

In an eighteenth aspect, in addition to one or more of the preceding or following aspects, or in the alternative to some aspects, the second flange portion the ear-wearable device can further include a supported portion, wherein the supported portion can be in contact with the ledge along the inner flange surface, and a non-supported portion, wherein the non-supported portion can be not in contact with the ledge along the inner flange surface.

In a nineteenth aspect, in addition to one or more of the preceding or following aspects, or in the alternative to some aspects, the vibrations of the receiver result in deformations of the non-supported portion.

In a twentieth aspect, an ear-wearable device can be included having a shell configured to fit within an ear of a user. The shell can be included having a shell cavity, and a shell opening to the shell cavity. The shell opening includes a ledge, a receiver disposed within the shell cavity, an acoustic tube. The acoustic tube can be configured to connect the receiver to the shell opening such that sounds generated by the receiver exit the ear-wearable device through the shell opening. The acoustic tube can be included having a stem. The stem can be included having a first end, wherein the first end can be connected to the receiver, and a second end, a flange connected to the second end. The flange configured to be positioned on the ledge along an inner flange surface such that the stem does not contact the shell. The flange can be included having a supported portion. The supported portion can be in contact with the ledge along the inner flange surface. The flange can include a non-supported portion. The non-supported portion can be not in contact with the ledge along the inner flange surface.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a partial cross-sectional view of ear anatomy in accordance with various embodiments herein.

FIG. 2 is a schematic view of an in-the-ear style custom ear-wearable device in accordance with various embodiments herein.

FIG. 3 is a schematic view of an in-the-ear style custom ear-wearable device in accordance with various embodiments herein.

FIG. 4 is a schematic view of an ear-wearable device 200 disposed within the ear of a user in accordance with various embodiments herein.

FIG. 5 is a bottom perspective view of an acoustic tube in accordance with various embodiments herein.

FIG. 6 is a top perspective view of the acoustic tube of FIG. 5 in accordance with various embodiments herein.

FIG. 7 is a cross-sectional view of an acoustic tube in an ear-wearable device in accordance with various embodiments herein.

FIG. 8 is a cross-sectional view of an acoustic tube in accordance with various embodiments herein.

FIG. 9 is a perspective view of an acoustic tube installed in an ear-wearable device in accordance with various embodiments herein.

FIG. 10 is a perspective, exploded view of an ear-wearable device with an acoustic tube separated from a remainder of the device, in accordance with various embodiments herein.

FIG. 11 is a perspective, exploded view of an alternate configuration of an ear-wearable device with an acoustic tube separated from a remainder of the device, in accordance with various embodiments herein.

FIG. 12 is a perspective view of an acoustic tube having a bridge in accordance with various embodiments herein.

FIG. 13 is a perspective view of an acoustic tube having a dome in accordance with various embodiments herein.

FIG. 14 is an exploded perspective view of an acoustic tube having a mesh layer in accordance with various embodiments herein.

FIG. 15 is a perspective view of an alternative configuration of an acoustic tube in accordance with various embodiments herein.

FIG. 16 is a schematic block diagram is shown with various components of an ear-wearable device in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

In some scenarios, the ear-wearable devices can suffer gain limitations due to mechanical vibrations. For instance, vibrations generated by the receiver may be picked up by the microphone, limiting the device output. In various embodiments, the acoustic channel of an ear-wearable device can be configured to transmit sounds generated by the receiver to an acoustic opening while damping the mechanical vibrations transmitted from the receiver to the other components of the ear-wearable device.

In various embodiments, an ear wearable device can include a shell configured to fit within an ear of a user. The shell can include a shell cavity and a shell opening to the shell cavity. The ear wearable device can include a receiver disposed within the shell cavity and an acoustic tube configured to connect the receiver to the shell opening such that sounds generated by the receiver exit the ear-wearable device through the shell opening. The acoustic tube can have a stem having a first end connected to the receiver and a second end. The acoustic tube can have a flange connected to the second end of the stem. In various embodiments, the flange is configured to contact the shell opening along an inner flange surface such that the stem does not contact the shell. In various embodiments, the flange is made from a deformable material such that vibrations of the receiver result in deformations of at least a portion of the flange.

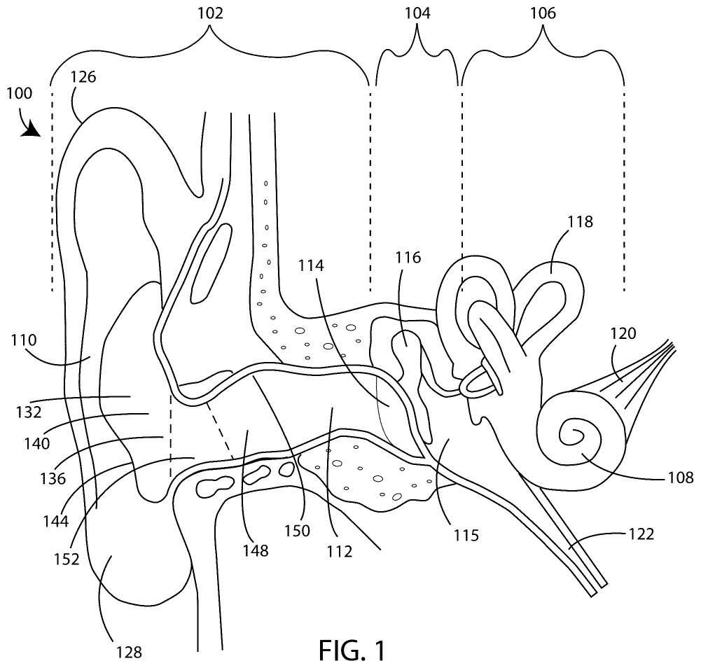

### Ear Anatomy and Ear-Wearable Device (FIGS. 1-4)

The term “ear-wearable device” shall refer to devices worn on or in the ear. Though not required, in some embodiments, ear-wearable devices can aid a person with hearing, such as a hearing assistance devices or hearing aids. Examples of hearing assistance devices are devices that can aid a person with impaired hearing or that can produce sounds, optimized sounds, or processed sound for persons with normal hearing. Hearing assistance devices herein can include hearables (e.g., wearable earphones, headphones, earbuds, virtual reality headsets), hearing aids (e.g., hearing instruments), cochlear implants, and bone-conduction devices, for example. Hearing assistance devices that are also custom ear-wearable devices include, but are not limited to, in-the ear (ITE), in-the-canal (ITC), invisible-in-canal (IIC), or completely-in-the-canal (CIC) type hearing assistance devices, or some combination of the above. Ear-wearable devices can also be used to block sound or even be unrelated to hearing. In some embodiments herein, an ear-wearable device may also take the form of a piece of jewelry, or a component of frames of glasses, that may be attached to the head on or about the ear. Ear-wearable devices can be worn within the ear in some embodiments.

Custom ear-wearable devices include at least one component, such as a shell, that is customized to the user's anatomy. Custom ear-wearable devices provide a number of advantages to the user. They can produce sound that seems more natural to the user because the hearing aid receiver, or speaker, is closer to the eardrum than non-custom ear-wearable devices. This proximity enables a higher-quality sound at a lower volume. Another contributor to quality is that the microphone can collect sound from in the ear itself, rather than from behind the ear. This takes advantage of the ear's pinna, the external part of the ear, to funnel sounds to the microphone. The microphone is also more shielded from wind in some embodiments. In various embodiments, custom ear-wearable devices are formed as a single housing, rather than two parts, and can therefore be easier for the user to put on.

Examples of different types of custom ear-wearable devices include the following, which are mentioned from larger to smaller: in-the-ear (ITE) ear-wearable devices, in-the-canal (ITC) ear-wearable devices, completely-in-canal (CIC) ear-wearable devices, and invisible (IIC) ear-wearable devices. Each of these custom ear-wearable devices has a different size and mates with a differently sized portion of the user's ear cavity.

Referring now to FIG. 1, a partial cross-sectional view of ear anatomy 100 is shown. The three parts of the ear anatomy 100 are the outer ear 102, the middle ear 104 and the inner ear 106. The inner ear 106 includes the cochlea 108. The outer ear 102 includes the pinna 110, ear canal 112, and the tympanic membrane 114 (or eardrum). The middle ear 104 includes the tympanic cavity 115, auditory bones 116 (malleus, incus, stapes) and the semicircular canals 118. The inner ear 106 includes the cochlea 108, and the auditory nerve 120. The pharyngotympanic tube 122 is in fluid communication with the Eustachian tube and helps to control pressure within the middle ear generally making it equal with ambient air pressure.

Sound waves enter the ear canal 112 and make the tympanic membrane 114 vibrate. This action moves the tiny chain of auditory bones 116 (ossicles-malleus, incus, stapes) in the middle ear 104. The last bone in this chain contacts the membrane window of the cochlea 108 and makes the fluid in the cochlea 108 move. The fluid movement then triggers a response in the auditory nerve 120.

Many components of the outer ear 102 interact with one or more styles of custom ear-wearable device. The helix 126 is the outer rim of the ear that extends from the scalp to the earlobe 128. The concha 132 is the deepest depression of the pinna 110 and is located at the opening 136, to the ear canal 112. The term ear cavity 140 will be used herein to describe the spaces defined by the concha 132 and the ear canal 112. The tragus (not shown in FIG. 1) is a small, pointed eminence positioned in front of the concha 132 and the antitragus 144 is a prominence opposite the tragus.

The ear canal 112 itself has physical features that custom ear-wearable devices contact. The bulbous area 148 and the second bend 150 are physical features of the ear canal 112, and the shell 204 of the ear-wearable device 200 is shaped to contact these features, in various embodiments. For example, an acoustic seal location 152, between the dashed lines in FIG. 1, is the portion of the ear anatomy where a circumferential seal will be formed with the ear-wearable device, in various embodiments.

Ear-wearable devices can include an enclosure, such as a housing or shell, within which internal components are disposed. Components of ear-wearable devices described herein can include a control circuit, digital signal processor (DSP), memory (such as non-volatile memory), power management circuitry, a data communications bus, one or more communication devices (e.g., a radio, a near-field magnetic induction device), one or more antennas, one or more microphones, a receiver/speaker, and various sensors as described in greater detail below. More advanced ear-wearable devices can incorporate a long-range communication device, such as a Bluetooth® transceiver or other type of radio frequency (RF) transceiver.

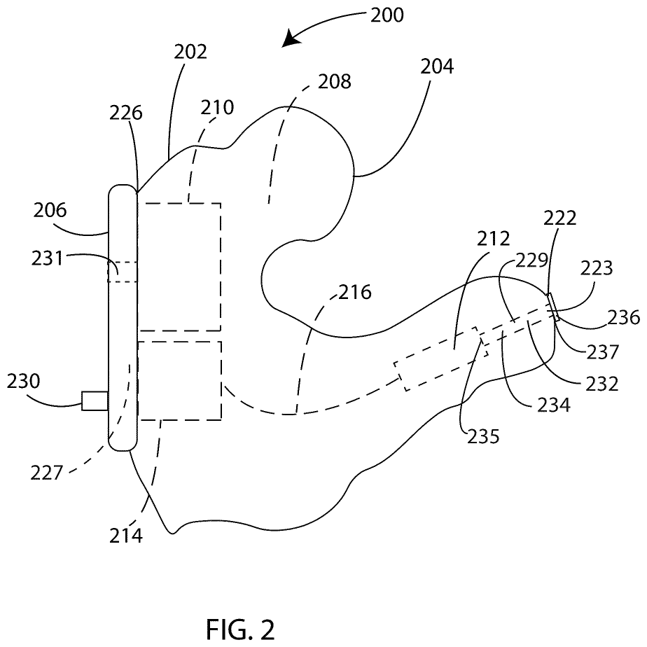

Referring now to FIG. 2, a schematic view of an in-the-ear style custom ear-wearable device 200 is shown in accordance with various embodiments herein. The ear-wearable device 200 can include an ear-wearable device housing 202 formed by a shell 204 and a faceplate 206. The shell 204 is custom shaped to mate with the user's ear anatomy and defines an internal shell cavity 208, a first shell opening 223, and a second shell opening 227 at the largest entrance to the shell cavity 208. The faceplate 206 is attached to the shell at the second shell opening 227 to enclose the shell cavity 208.

The ear-wearable device housing 202 can define a battery compartment 210 in which a battery can be disposed to provide power to the device. The housing 202 can also define a component compartment 214 that can contain electrical and other components including but not limited to a microphone, a processor, memory, various sensors, one or more communication devices, power management circuitry, and a control circuit. A cable 216 or connecting wire can include one or more electrical conductors and provide electrical communication between components inside of the component compartment 214 and components inside of the receiver 212.

The shell 204 extends from a first end 222 to a second end 226. The first end 222 can interface with the ear canal and can have a first shell opening 223. At the second end 226, the shell 204 defines a second shell opening 227 that is closed by the faceplate 206. The faceplate 206 is sealed to the shell 204. The faceplate 206 is shown in FIG. 2 only in a side view but can include many features and structures. A user input device 230 is shown as part of the faceplate in FIG. 2, and can be a button, lever, switch, dial, or other input device. One or more microphones 231 may also be mounted to the faceplate 206. The faceplate 206 may also include a battery door, a pull handle, and other features.

The ear-wearable device 200 can also include a receiver 212. The receiver 212 can include a component that converts electrical impulses into sound, such as an electroacoustic transducer, speaker, or loudspeaker. In the context of ear-wearable devices, one or more microphones (e.g., microphone(s) 231 on faceplate 206) gather acoustic energy (sound) from the surrounding environment and convert the acoustic energy into electrical signals. In some embodiments, the electrical signals are then transmitted to an amplifier which increases the amplitude of the electric signals. The amplified electric signals are then transmitted to the receiver 212, which converts the received electric signals into sounds. The sounds are then transmitted to a user's ear via an acoustic outlet at the first shell opening 223 of the ear-wearable device 200. Any suitable type or types of receiver can be used in the ear-wearable device 200 including, but not limited to armature receivers, moving coil receivers, or the like.

In various embodiments, sounds generated by the receiver 212 travel through an acoustic channel 229 and exit the ear-wearable device 200 at the first shell opening 223. In various embodiments, the acoustic channel 229 is defined by an acoustic channel wall. In some embodiments, the acoustic channel wall can be formed from a portion of the ear-wearable device housing 202, such as during a molding process that forms the shell 204. Alternatively, the acoustic channel wall can be formed from a structure separate from the ear-wearable device housing 202, such as a one or more tubes inserted and attached to the shell 204.

Some ear-wearable devices suffer gain limitations due to mechanical vibrations where mechanical vibrations are generated by moving parts within the ear-wearable device 200, such as an armature of the receiver 212. For instance, vibrations generated at the receiver 212 may be transmitted via the acoustic channel wall to the shell 204 and faceplate 206 of the ear-wearable device 200. As depicted by FIG. 2, the faceplate 206 can contain one or more microphones 231. In some embodiments, the microphone(s) 231 mounted to the faceplate 206 perceive the mechanical vibrations generated by the receiver 212 as sounds. Such an effect creates a closed positive feedback loop wherein the microphone output is proportional to the receiver output.

In various embodiments, the acoustic channel 229 of the ear-wearable device 200 can transmit sounds generated by the receiver 212 to the first shell opening 223 while the acoustic channel wall serves to dampen the mechanical vibrations transmitted from the receiver 212 to other components of the ear-wearable device 200 (e.g., the shell 204 and faceplate 206). In the example of FIG. 2, the acoustic channel 229 can be defined by an acoustic tube 232. In various embodiments, an ear-wearable device comprises an acoustic channel 229 defined by an acoustic channel wall, and the acoustic channel wall comprises or is an acoustic tube 232. In various embodiments, the acoustic tube 232 is configured to define the acoustic channel for the ear-wearable device 200 and to insulate the ear-wearable device shell 204 and faceplate 206 from the mechanical vibrations generated by the receiver 212.

In various embodiments, the acoustic tube 232 is configured to connect the receiver 212 to the first shell opening 223 such that sounds generated by the receiver propagate through the acoustic tube and exit the ear-wearable device 200 through the shell opening. In various embodiments, the acoustic tube can include a stem 234 having a first end 235 connected to the receiver 212 a second end 237 connected to a flange 236.

In various embodiments, the stem 234 of the acoustic tube 232 can be formed from one or more tubes made from or including a rubber or elastomer material such as a tube made from or including Viton™ fluoroelastomer materials made by The Chemours Company, having a place of business in Wilmington, Delaware, USA. In some embodiments, at least a portion of the stem 234 of the acoustic tube 232 can be inserted into an existing acoustic channel 229 of the ear-wearable device 200. Alternatively, the stem 234 of the acoustic tube 232 itself can form the acoustic channel wall of the ear-wearable device 200.

In various embodiments, a portion of the flange 236 of the acoustic tube 232 is configured to contact the shell 204 adjacent to the first shell opening 223 such that the stem 234 does not contact the shell. In various embodiments, the flange 236 is constructed from a deformable material such that vibrations of the receiver 212 result in deformations of at least a portion of the flange. By creating a flexible boundary between the acoustic tube 232 and the shell 204 via the deformable flange 236, at least a portion of the vibrations generated by the receiver 212 are absorbed by the flange rather than being transmitted to the shell 204 and faceplate 206 of the ear-wearable device 200.

In the example of FIG. 2, the flange 236 of the acoustic tube 232 is configured to rest on an outer surface of the shell 204 around the first shell opening 223 of the ear-wearable device 200. In alternative embodiments, the flange 236 of the acoustic tube 232 is configured to be recessed from the outer surface of the shell 204.

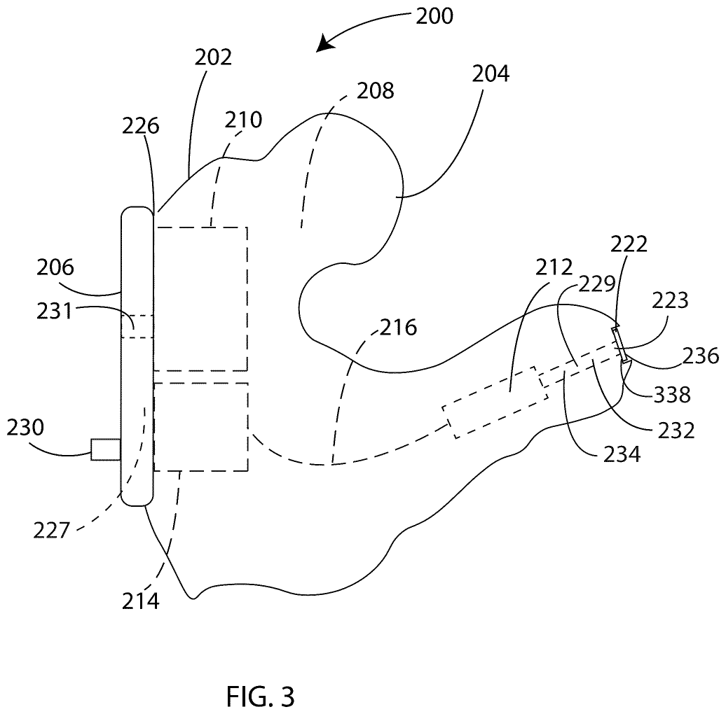

Referring now to FIG. 3, a schematic view of an in-the-ear style custom ear-wearable device 200 is shown in accordance with various embodiments herein. The ear-wearable device 200 of FIG. 3 is substantially similar to the ear-wearable device of FIG. 2, but the shell 204 contains a ledge 338 surrounding the first shell opening 223. The ledge can be recessed from the outer surface of the shell 204. While the ear-wearable device 200 of FIG. 3 contains a single ledge 338, it is possible for the first shell opening 223 to have two, three, or more ledges.

In various embodiments, a portion of the flange 236 of the acoustic tube 232 is configured to contact the shell 204 opening along the ledge 338 such that the stem 234 does not contact the shell 204. Such an embodiment can be advantageous because the top surface of the flange 236 can be flush with or recessed from the outer surface of the shell 204. Such a configuration may result in increased user comfort, improved appearance of the ear-wearable device 200 and reduce the risk of the acoustic tube 232 becoming dislodged from the ear-wearable device.

The ear-wearable device 200 shown in FIGS. 2-3 is an in-the-ear style device and thus the shell is designed to be placed within the ear cavity. However, it will be appreciated that many different form factors for ear-wearable devices are contemplated herein. Aspects of ear-wearable devices and functions thereof are described in U.S. Pat. No. 9,848,273; U.S. Publ. patent application No. 20180317837; and U.S. Publ. patent application No. 20180343527, the content of all of which is herein incorporated by reference in their entirety.

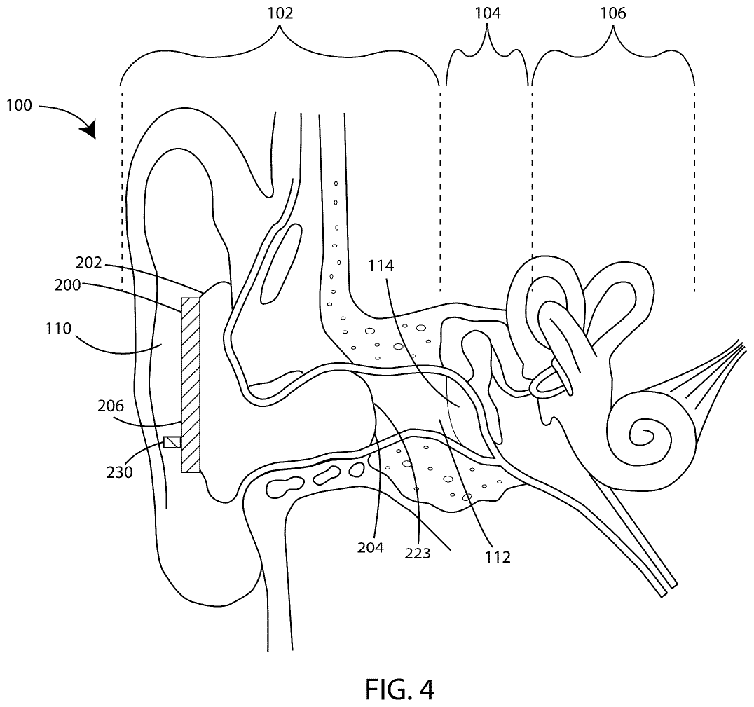

Referring now to FIG. 4, a schematic view of an ear-wearable device 200 disposed within the ear of a user is shown in accordance with various embodiments herein. The housing 202 of the ear-wearable device 200 is defined by the shell 204, which is positioned within the ear canal 112, and the faceplate 206, which is positioned in the concha. The user input device 230 on the faceplate 206 is accessible to be manipulated by the user without having to remove the ear-wearable device from their ear. The first shell opening 223 is positioned close to the user's tympanic membrane. In various embodiments, the shell 204 fits properly within the user's ear cavity. A proper fit is usually one in which the ear-wearable device forms an acoustic seal with the user's ear cavity, so that it is contacting the ear cavity around a circumference of the ear-wearable device at some location on the shell 204 of the ear-wearable device 200. A proper fit is also comfortable for the user, so that the shell 204 does not put too much pressure on the walls of the ear canal 112 or features of the concha. In various embodiments, the receiver 212 (FIG. 2) is positioned within the shell 204 at the first end 222 of the shell 204 to minimize the distance between the receiver 212 and the tympanic membrane 114 without physically contacting the tympanic membrane 114.

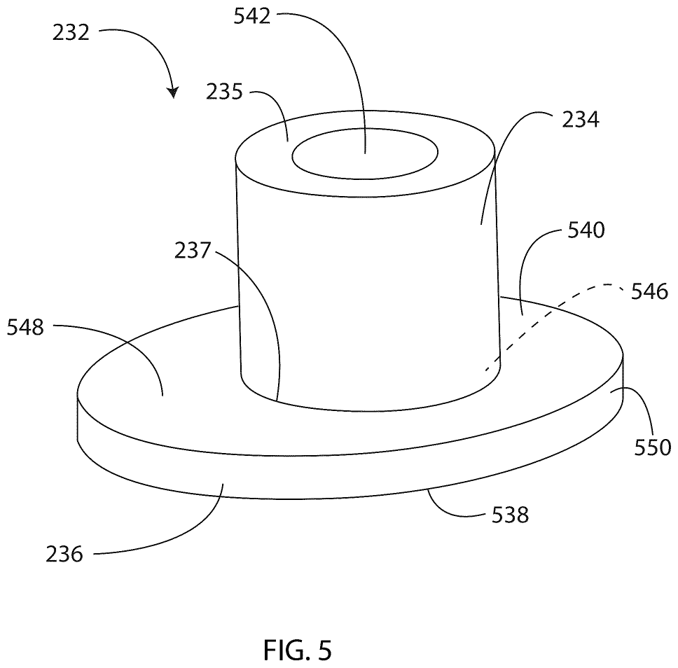

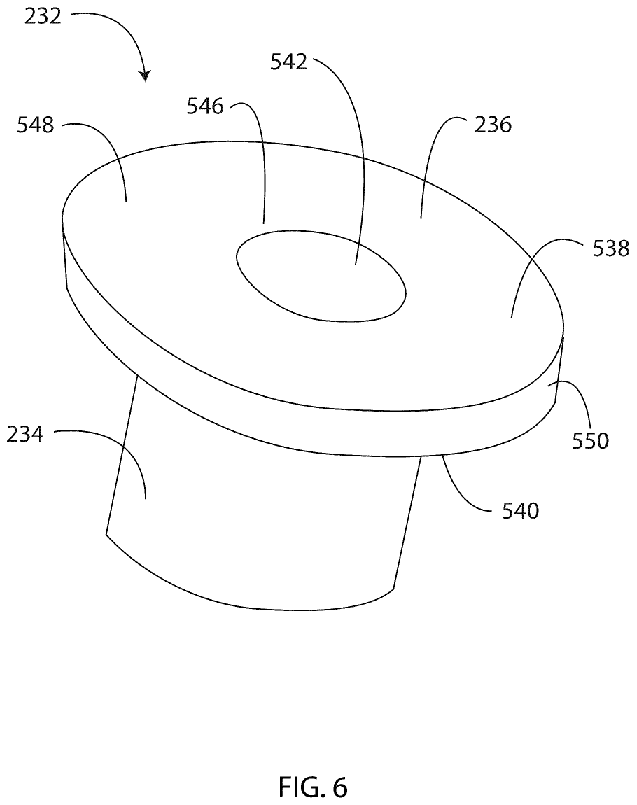

### Acoustic Tube Configurations (FIGS. 5-6)

Referring now to FIGS. 5-6, perspective views of an acoustic tube are shown in accordance with various embodiments herein. FIG. 5 depicts a bottom perspective view of an acoustic tube. FIG. 6, a top perspective view of the acoustic tube of FIG. 5.

In various embodiments, the acoustic tube 232 can include a stem 234 and a flange 236. The stem 234 can include a first end 235 configured to connect to a receiver (e.g., receiver 212 of ear-wearable device 200). In various embodiments, the acoustic tube 232 includes an acoustic opening 542 that is configured to function as the acoustic passage of an ear-wearable device 200. The acoustic opening 542 is configured to be in acoustic communication with the receiver 212 at the first end 235 of the stem 234. The stem 234 can include a second end 237 connected to the flange 236. As best seen in FIG. 6, the acoustic opening 542 extends all the way though the stem 234 and flange 236 of the acoustic tube, such that sounds generated by the receiver 212 are configured to propagate through the acoustic opening 542 of the acoustic tube 232.

In various embodiments, the flange 236 is connected to the second end 237 of the stem 234. The flange 236 can include an outer flange surface 538 and an inner flange surface 540. The flange 236 is configured to contact the first shell opening 223 of an ear-wearable device 200 along the inner flange surface 540 such that the stem 234 does not contact the shell 204.

The flange 236 can include a first flange portion 546 and a second flange portion 548. The first flange portion 546 is configured to connect to the second end 237 of the stem 234 along the inner flange surface 540. The second flange portion 548 surrounds the first flange portion 546 and is not directly connected to the second end 237 of the stem 234. In various embodiments, the second flange portion 548 is configured to contact the first shell opening 223 along the inner flange surface 540 and/or at a flange outer perimeter surface 550. Generally, there is a gap between where the second flange portion 548 contacts the first shell opening 223 and the first flange portion 546, such that the stem 234 does not contact the shell 204 when the acoustic tube 232 is inserted into the ear-wearable device 200.

In various embodiments, the acoustic tube 232 is constructed such that deformations of the flange 236 reduce transmission of vibrations from the receiver 212 to the shell 204 of the ear-wearable device. In various embodiments, the stem 234 and flange 236 each have a natural vibration mode. The stem 234 and flange 236 can each be sized to have a natural vibration mode at a specific frequency. In various embodiments, the stem 234 and flange 236 can each be sized to have a natural vibration mode within the acoustic frequency range (in which frequencies can be detected by the human ear) where we are most concerned about feedback, such as 20 Hertz to 20,000 Hertz. In some embodiments, the stem 234 and flange 236 can each be sized to vibrate at a frequency chosen such that the outer perimeter surface 550 of the flange 236 remains stationary as the acoustic tube 232 vibrates. For instance, the stem 234 and flange 236 can each have a natural vibration mode having a frequency corresponding to a wavelength that is half of the diameter of the flange, a full diameter of the flange, or any other suitable half wavelength multiple of the flange diameter. Such half wavelength deformations of the flange 236 effectively create a stationary boundary condition at the outer diameter of the flange, which functions to prevent vibrations from the receiver 212 from propagating to the shell 204 of the ear-wearable device 200.

In various embodiments, the acoustic tube 232 is constructed from a deformable material such that vibrations of the receiver 212 result in deformations of at least a portion of the flange 236. In various embodiments, the acoustic tube 232 is made of any suitable material or materials including, but not limited to fluorelastomeric materials such as Viton™ fluoroelastomer materials, rubbers such as neoprene, silicone, other ductile polymers, or the like.

In various embodiments, acoustic tube 232 is from or includes a material or materials with a sufficiently high elasticity such that such that deformations of the flange 236 reduce transmission of vibrations from the receiver 212 to the shell 204 of the ear-wearable deice. In some embodiments, the modulus of elasticity of the acoustic tube 232 can be greater than or equal to 5 megapascals (MPa), 7 MPa, 9 MPa, 11 MPa, 13 MPa, or 15 MPa, or can be an amount falling within a range between any of the foregoing.

In some embodiments, the flange 236 and the stem 234 are formed from the same material or materials. In some embodiments, the flange 236 and the stem 234 are formed from different materials. In various embodiments, the acoustic tube can be formed from any suitable process or processes such as injection molding, or the like. In some embodiments, flange 236 is formed integrally with the stem 234. In some embodiments, the flange 236 and the stem 234 are formed separately and subsequently joined together by any suitable means such as adhesives, or the like.

In the example of FIGS. 5-6, flange 236 is annular in shape and radially symmetric about the acoustic opening 542. However, any other suitable shape of flange 236 that is configured to dampen the vibrations from the receiver 212 can be used. The flange is generally shaped to lay over and fit around the first shell opening of an ear-wearable device (such as depicted by FIG. 2) or within a ledge (e.g., ledge 338) defined around the first shell opening (such as depicted by FIG. 3). For instance, a square-shaped flange can be constructed to connect to a square-shaped ledge defined with the first shell opening of an ear-wearable device.

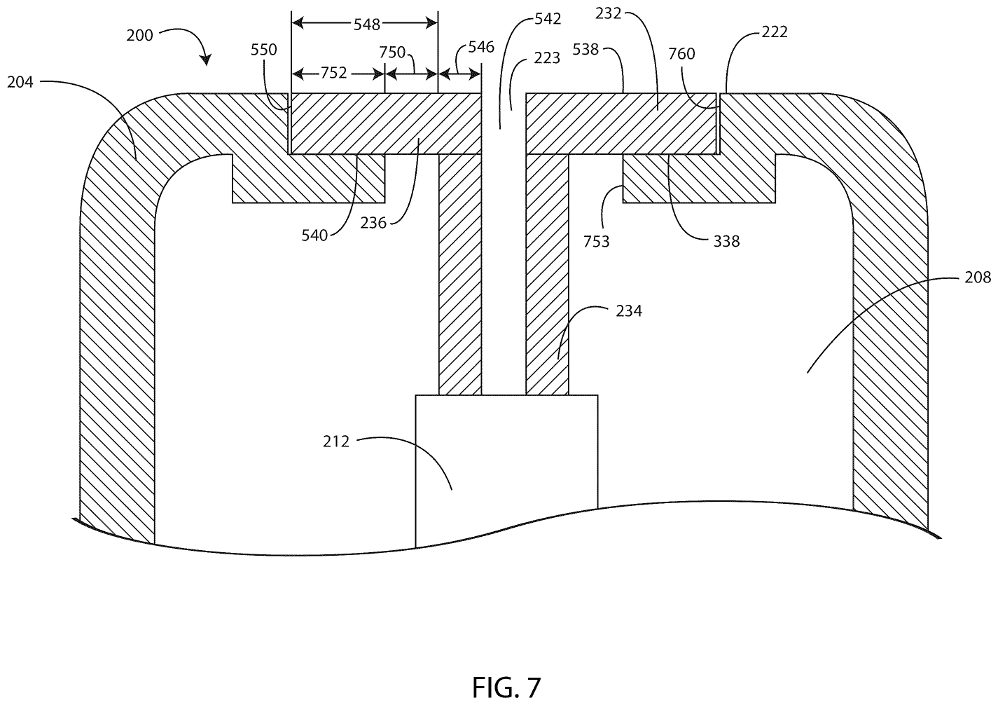

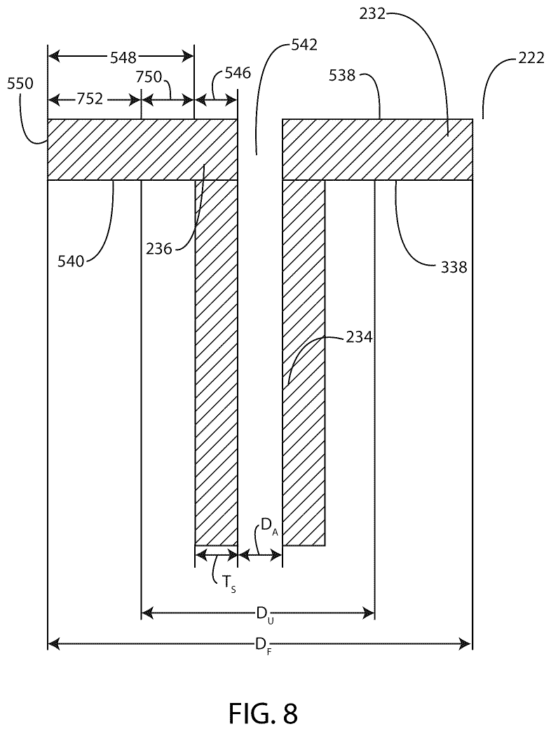

### Flange Portions and Dimensions (FIGS. 7-8)

Referring now to FIG. 7, a cross-sectional view of an acoustic tube in an ear-wearable device is shown in accordance with various embodiments herein. In the example of FIG. 7, the shell 204 of the ear-wearable drive 200 defines a ledge 338 around the first shell opening 223. The ledge 338 is recessed from the topmost surface of the shell 204. In various embodiments, the flange 236 of the acoustic tube 232 is configured to be positioned on the ledge 338, with the inner flange surface 540 contacting the ledge 338. In various embodiments, the flange 236 is fixedly joined to the shell 204 such that the flange's area of contact with the ledge 338 cannot move with respect to the shell. In various embodiments, the acoustic tube 232 is joined to the shell 204 around the outer perimeter surface 550 of the flange 236. In various embodiments, the acoustic tube 232 is joined to the shell 204 only around the outer perimeter surface 550 of the flange 236, such as to preserve the natural vibration mode of the acoustic tube 232. The outer perimeter surface 550 of the flange 236 can be attached via adhesive to the inner circumference surface 760 of the first shell opening 223, in various embodiments.

Adhesives or welding can be used to join the components. In various embodiments, care is taken so that adhesive is only present at the outer perimeter surface 550 of the flange and that adhesive does not spread or spill onto the inner flange surface 540 or outer flange surface 538. The presence of adhesive on the inner flange surface or outer flange surface has the potential to make the flange stiff at that location, reducing the vibration insulation benefit.

In other embodiments, the inner flange surface 540 of the acoustic tube 232 can be joined to the shell 204, such as to the ledge 338, by any suitable means, such as adhesives, or the like. In various embodiments, care is taken so that adhesive is only present at an overlap between the inner flange surface 540 and the ledge 338 and that adhesive does not spread or spill further onto the inner flange surface 540 or outer flange surface 538.

In the example of FIG. 7, the flange 236 of the acoustic tube 232 is sized such that the outer flange surface 538 is flush with or substantially flush with the topmost surface of the shell 204. In other words, the outer flange surface 538 is smoothly aligned with the outer surface of the shell 204. In various embodiments, the outer flange surface 538 does not stick out from the outer surface of the shell 204. In some embodiments, the outer flange surface 538 can protrude from or be recessed from topmost surface of the shell 204. In alternate configurations, ear-wearable drive 200 does not have a ledge around the first shell opening 223 and the acoustic tube can be joined to the topmost surface of the shell 204.

In various embodiments, the flange 236 can include a first flange portion 546 configured to connect to the second end 237 of the stem 234 along the inner flange surface 540. The flange 236 can include a second flange portion 548 surrounding the first flange portion 546. The second flange portion 548 can include a supported portion 752 and a non-supported portion 750. In various embodiments, the supported portion 752 is in contact with the ledge 338 of the ear-wearable device 200 along the inner flange surface 540. In various embodiments, the non-supported portion 750 is not in contact with the ledge 338 of the ear-wearable device 200 along the inner flange surface 540. In various embodiments, the non-supported portion 750 of the flange 236 is configured to prevent the stem 234 from contacting the shell 204 of the ear-wearable device.

In various embodiments, vibrations of the receiver 212 are transmitted to the stem 234 of the acoustic tube 232. As the stem 234 is fixedly attached to the flange 236, vibrations of the stem result in deformations of the non-supported portion 750 of the flange. The deformations of the non-supported portion 750 absorb at least a portion of the vibrations generated at the receiver 212, reducing the transmission of vibrations from the receiver 212 to the shell 204 and faceplate 206 of the ear-wearable device 200. Ideally, the acoustic tube 232 is configured to vibrate at a resonance that is a half wavelength multiple of the flange diameter such that the outer diameter of the flange remains stationary as the acoustic tube vibrates.

The boundary between the supported portion 752 and the non-supported portion 750 of the flange 236 is determined by where the inner flange surface 540 meets the innermost edge 753 of the ledge 338. In the example of FIG. 7, the supported portion 752 and the non-supported portion 750 are approximately annular in shape. However, the shapes of the supported portion 752 and the non-supported portion 750 may vary depending on the geometry of the flange 236, the desired vibration mode of the acoustic tube, and/or the geometry of the ledge 338.

Referring now to FIG. 8, a cross-sectional view of an acoustic tube is shown in accordance with various embodiments herein. In various embodiments, the acoustic tube can include a stem 234, a flange 236 and an acoustic opening 542 through the flange and stem. The flange 236 can include a first flange portion 546 configured to connect to the second end 237 of the stem 234 along the inner flange surface 540 and a second flange portion 548 surrounding the first flange portion 546. The second flange portion 548 can include a supported portion 752 and a non-supported portion 750.

In various embodiments, the acoustic opening has a diameter DA. In various embodiments, the diameter DA is chosen such that the acoustic tube 232 vibrates at a resonance that is a half wavelength multiple of the flange diameter. In some embodiments, the diameter DA can be greater than or equal to 0.5 mm, 0.7 mm, 0.8 mm, or 1.0 mm. In some embodiments, the diameter DA can be less than or equal to 1.5 mm, 1.3 mm, 1.2 mm, or 1.0 mm. In some embodiments, the diameter DA can fall within a range of 0.5 mm to 1.5 mm, or 0.7 mm to 1.3 mm, or 0.8 mm to 1.2 mm, or can be about 1.0 mm.

In the example of FIG. 8, the acoustic opening 542 has a constant diameter along its length, but in alternative embodiments, the diameter of the acoustic opening may vary along its length. In the example of FIG. 8, acoustic opening 542 is circular in cross section, but other cross-sectional shapes are possible such as square, or the like.

In various embodiments, the wall of stem 234 of the acoustic tube 232 has a thickness Ts. In various embodiments, the thickness Ts is chosen such that the acoustic tube 232 vibrates at a resonance that is a half wavelength multiple of the flange diameter. In some embodiments, the thickness Ts can be greater than or equal to 0.25 mm, 0.33 mm, 0.42 mm, or 0.50 mm. In some embodiments, the thickness Ts can be less than or equal to 0.75 mm, 0.67 mm, 0.58 mm, or 0.50 mm. In some embodiments, the thickness Ts can fall within a range of 0.25 mm to 0.75 mm, or 0.33 mm to 0.67 mm, or 0.42 mm to 0.58 mm, or can be about 0.50 mm.

In the example of FIG. 8, the stem 234 has a constant diameter along its length, but in alternative embodiments, the diameter of the stem 234 may vary along its length. In the example of FIG. 8, stem 234 is annular in cross section, but other cross-sectional shapes are possible.

In various embodiments, the flange 236 of the acoustic tube 232 has an outer diameter DF. In various embodiments, the outer diameter DF is chosen such that the acoustic tube 232 vibrates at a resonance that is a half wavelength multiple of the flange diameter. In some embodiments, the diameter DF can be greater than or equal to 2.0 mm, 2.7 mm, 3.3 mm, or 4.0 mm. In some embodiments, the diameter DF can be less than or equal to 6.0 mm, 5.3 mm, 4.7 mm, or 4.0 mm. In some embodiments, the diameter DF can fall within a range of 2.0 mm to 6.0 mm, or 2.7 mm to 5.3 mm, or 3.3 mm to 4.7 mm, or can be about 4.0 mm.

In some embodiments, the diameter DF can be greater than or equal to 1.0 mm, 1.2 mm, 1.4 mm, 1.6 mm, 1.8 mm, 2.0 mm, 2.2 mm, or 2.4 mm. In some embodiments, the diameter DF can be less than or equal to 4.0 mm, 3.8 mm, 3.5 mm, 3.3 mm, 3.1 mm, 2.9 mm, 2.6 mm, or 2.4 mm. In some embodiments, the diameter DF can fall within a range of 1.0 mm to 4.0 mm, or 1.2 mm to 3.8 mm, or 1.4 mm to 3.5 mm, or 1.6 mm to 3.3 mm, or 1.8 mm to 3.1 mm, or 2.0 mm to 2.9 mm, or 2.2 mm to 2.6 mm, or can be about 2.4 mm.

In the example of FIG. 8, flange 236 has a constant outer diameter at different radial locations, but in alternative embodiments, the outer diameter of the flange may vary for different diameter locations. In the example of FIG. 8, the flange 236 is annular in shape, but the flange may be any suitable shape that is compatible to fit within the first shell opening of an ear-wearable device.

In various embodiments, non-supported portion 750 of flange 236 has an outer diameter Du. In various embodiments, the outer diameter Du is chosen such that the acoustic tube 232 vibrates at a resonance that is a half wavelength multiple of the flange diameter. In some embodiments, the diameter Du can be greater than or equal to 1.0 mm, 1.7 mm, 2.3 mm, or 3.0 mm. In some embodiments, the diameter Du can be less than or equal to 5.0 mm, 4.3 mm, 3.7 mm, or 3.0 mm. In some embodiments, the diameter Du can fall within a range of 1.0 mm to 5.0 mm, or 1.7 mm to 4.3 mm, or 2.3 mm to 3.7 mm, or can be about 3.0 mm.

In the example of FIG. 8, non-supported portion 750 of flange 236 has a constant outer diameter, but in alternative embodiments, the outer diameter of the non-supported portion 750 may vary at different diameter locations. In the example of FIG. 8, non-supported portion 750 of flange 236 is annular in shape, but the flange may be any suitable shape that is compatible to fit within the first shell opening of an ear-wearable device.

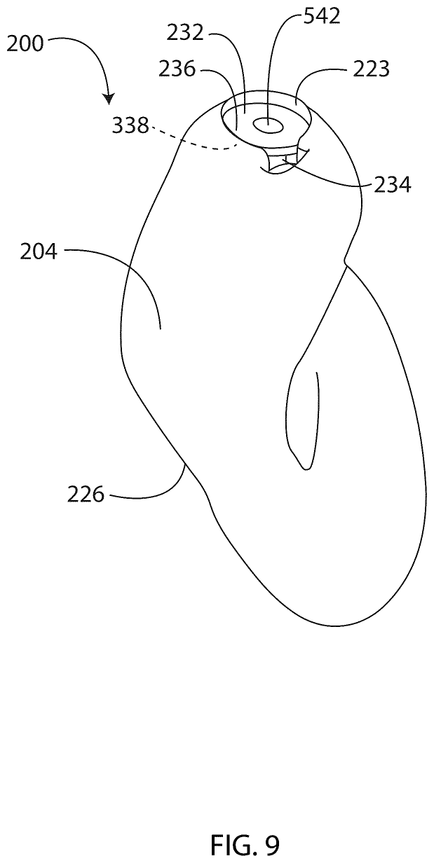

### Acoustic Tube in an Ear-Wearable Device (FIGS. 9-11)

Referring now to FIG. 9, a perspective view of an acoustic tube installed in an ear-wearable device is shown in accordance with various embodiments herein. The ear-wearable device 200 of FIG. 9 includes an acoustic tube 232 that is configured to connect the receiver 212 to the first shell opening 223 such that sounds generated by the receiver exit the ear-wearable device 200 through the shell opening.

In various embodiments, the shell 204 contains a ledge 338 surrounding the first shell opening 223. The ledge can be recessed from the outer surface of the shell 204. In various embodiments, a portion of the flange 236 of the acoustic tube 232 is configured to contact the first shell opening 223 along the ledge 338 such that the stem 234 does not contact the shell 204. In the example of FIG. 9, the flange 236 of the acoustic tube 232 is recessed from the outermost surface of the shell 204.

The acoustic tube 232 can be assembled and integrated into the ear-wearable device 200 in a number of ways. In various embodiments, the first end 235 of the stem 234 is attached to the receiver 212 prior to inserting the both the receiver 212 and acoustic tube 232 into the ear-wearable device 200. In alternate embodiments, the first end 235 of the stem 234 may be attached to a receiver 212 that is already installed within the shell 204 an ear-wearable device 200.

In various embodiments, the stem 234 of the acoustic tube 232 can be inserted into the ear-wearable device 200 through the first shell opening 223. The flange 236 of the acoustic tube 232 can then be positioned on the first shell opening 223 (e.g., along ledge 338) on its inner flange surface 540. The inner flange surface 540 can then be joined to the shell 204 using any suitable means such as adhesives or the like. In various embodiments, the adhesive is limited to being present at the ledge, and the adhesive is not applied to the flange except where the flange would overlap with the ledge. A lack of adhesive will result in preserving the flexibility of the non-supported portion of the flange.

Alternatively, the acoustic tube 232 can be inserted into the ear wearable device 200 through the second shell opening 227 prior to installing the faceplate 206. Such a setup is required in scenarios where the receiver 212 does not fit through the first shell opening 223. Due to its deformable nature, the flange 236 of the acoustic tube 232 can then be squeezed though the first shell opening 223, leaving the stem and receiver 212 inside of the ear-wearable device. The flange 236 of the acoustic tube 232 can then be positioned on the first shell opening 223 (e.g., along ledge 338) on its inner flange surface 540. The inner flange surface 540 can then be joined to the shell 204 using any suitable means such as adhesives or the like. In various embodiments, the acoustic tube 232 is joined to the shell 204 only around the outermost perimeter of the inner flange surface 540 such as to preserve the natural vibration mode of the acoustic tube 232. In various embodiments, the flange includes a non-supported portion.

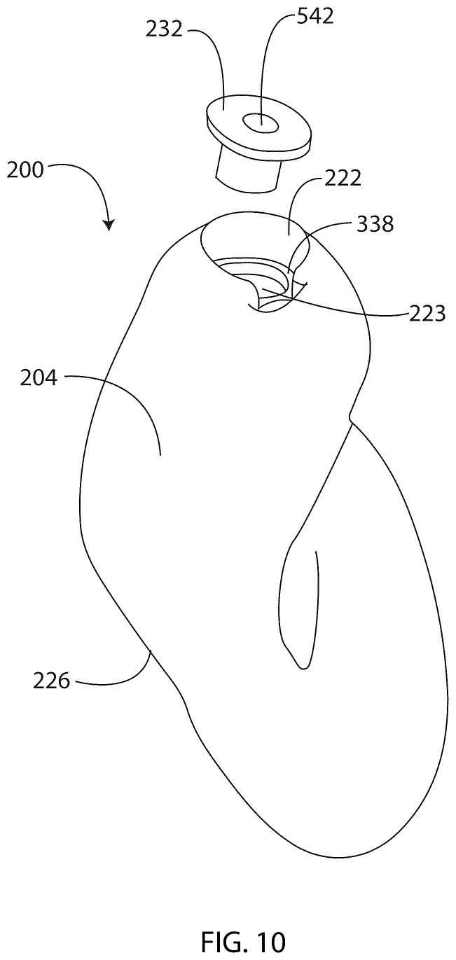

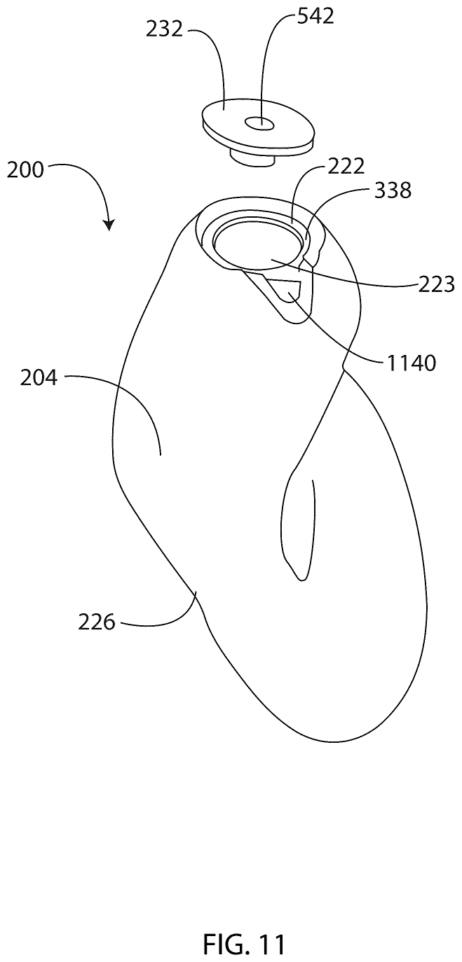

Referring now to FIGS. 10-11, perspective exploded views of ear-wearable devices are shown in accordance with various embodiments herein. FIG. 10 depicts a perspective view of an ear-wearable device with the acoustic tube separated from the shell. FIG. 11 depicts a perspective view of an alternate configuration of an ear-wearable device with the acoustic tube separated from the shell.

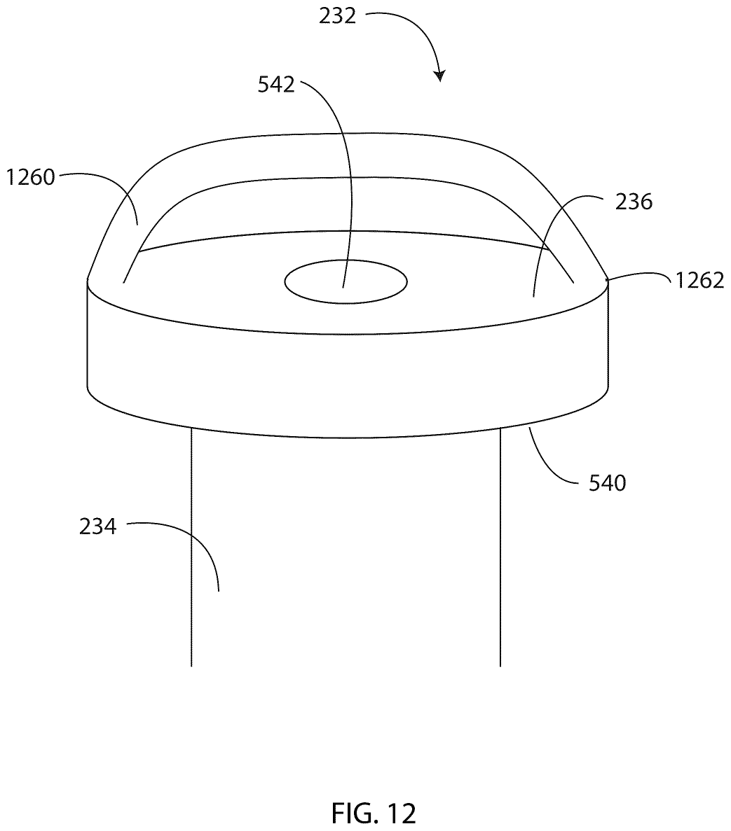

In the example of FIGS. 11 and 12, the shell 204 of the ear-wearable drive 200 defines a ledge 338 around the first shell opening 223. The ledge 338 is recessed from the topmost surface of the shell 204. In various embodiments, the flange 236 of the acoustic tube 232 is configured to be positioned on the ledge 338 along the inner flange surface 540. However, the ledge 338 of FIG. 10 is recessed deeper than the ledge of FIG. 11, such that acoustic tube of FIG. 10 will sit lower with respect to the outer shell surface than the acoustic tube of FIG. 11.

FIG. 10 depicts an ear-wearable device 200 with a smaller first shell opening 223, while FIG. 11 depicts an ear-wearable device 200 with a larger first shell opening 223. Due to the larger diameter of the first shell opening 223 of FIG. 11, it is expected that the flange 236 will vibrate at a lower resonance frequency than the flange of FIG. 10, assuming that both flanges have the same thickness. It is expected that the flange having a lower resonance frequency will produce better vibration insulation at higher frequencies that are beyond the flange's own resonance. However, having a larger shell opening may make the ear-wearable device more susceptible to foreign material and damage.

Another difference between the ear-wearable devices 200 of FIGS. 10 and 11 is that the shell 204 of FIG. 11 includes a ventilation hole 1140. In various embodiments, the ventilation hole 1140 can protect the interior components of the ear-wearable device from pressure differentials and can prevent water vapor from condensing inside of the shell 204. The ventilation hole 1140 can also enhance the performance of certain types of receivers, such as vented receivers.

Foreign Matter Protection (FIGS. 12-14)

In various embodiments, the acoustic opening 542 can provide an entry point for foreign matter into the ear-wearable device 200. Foreign matter as defined herein is any matter other than air that can enter the ear-wearable device and can include skin cells, dust, body oil, food, hairspray, ear wax, water, or the like. Performance of the audio components placed in ear canal (e.g., the receiver 212) tends to suffer when foreign matter plugs the acoustic ports. In severe cases, foreign matter can collect within the acoustic opening to the point that the acoustic opening is almost entirely obstructed, resulting in dramatic change in acoustic impedance and effective reduction of device output.

For this reason, it can be desirable to incorporate one or more debris mitigation measures along with the acoustic tube 232. In various embodiments, the ear-wearable device 200 can include a structure placed over the first shell opening 223 that is configured to obstruct debris from passing through the first shell opening. Several non-limiting examples of such structures are described in greater detail herein.

Referring now to FIG. 12, a perspective view of an acoustic tube having a bridge is shown in accordance with various embodiments herein. In various embodiments, the acoustic tube can include a stem 234, a flange 236 and an acoustic opening 542 through the flange and stem. In the example of FIG. 12, the acoustic tube 232 can further include a bridge 1260 attached to flange 236 that is configured to cover at least a portion of the acoustic opening 542. In various embodiments, the bridge 1260 can be formed integrally with the flange 236. Alternatively, the bridge 1260 may be formed separately from the flange 236 and subsequently joined to the flange using any suitable means such as adhesives or the like.

In various embodiments, the bridge 1260 is configured to minimize the number of ledges, corners, and crevices on the acoustic tube. For instance, the bridge 1260 of FIG. 12 is connected to the flange 236 such that the outer surface of the bridge is flush with the outer perimeter 1262 of the flange. Such a configuration creates a smooth boundary between the bridge 1260 and flange 236 enhancing user comfort. Moreover, the profile of the bridge 1260 provides a smooth shape with minimal ledges, reducing the number of surfaces that foreign material may become trapped in.

In various embodiments, the bridge 1260 is positioned on the flange 236 of the acoustic tube 232 such that the bridge covers at least a portion of the acoustic opening 542. In various embodiments, the bridge 1260 is substantially wide to prevent foreign material from entering the ear-wearable device 200 via the acoustic opening 542. In various embodiments, the bridge 1260 is sufficiently narrow as to not completely cover the acoustic opening 542 in order to preserve sound quality. For instance, in embodiments where the acoustic opening 542 has a diameter DA of approximately 1 mm, the bridge 1260 may have a width of greater than 0.25 mm, but less than 1 mm.

The bridge 1260 can be formed from any suitable material or materials including, but not limited to fluorelastomeric materials such as Viton™ fluoroelastomer materials, rubbers such as neoprene, silicone, other ductile polymers, or the like. In various embodiments, bridge 1260 can be formed from a complaint material to enhance user comfort when the ear-wearable device 200 is placed in the ear. In various embodiments, bridge 1260 can be formed from the same material or materials as the acoustic tube 232. Alternatively, the bridge 1260 can be formed from different materials than the acoustic tube 232.

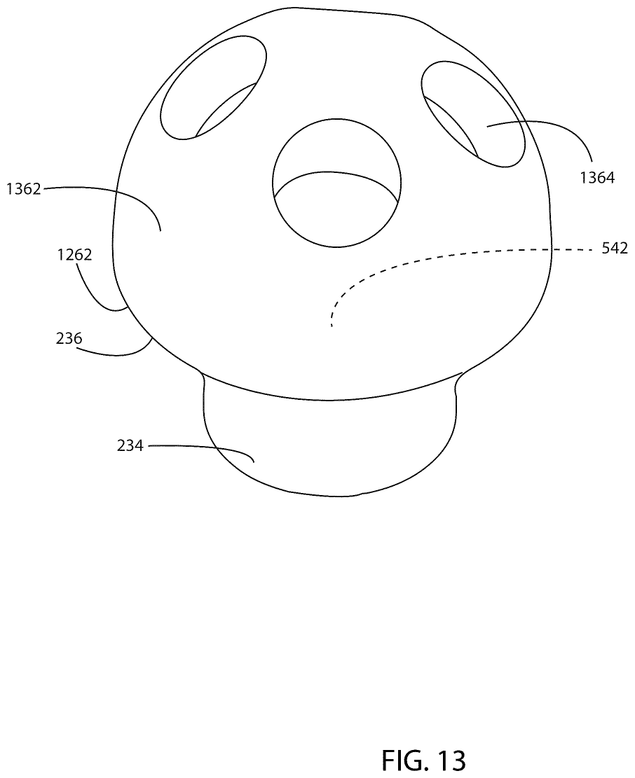

Referring now to FIG. 13, a perspective view of an acoustic tube having a dome is shown in accordance with various embodiments herein. In various embodiments, the acoustic tube can include a stem 234, a flange 236 and an acoustic opening 542 through the flange and stem. The acoustic tube 232 can further include a dome 1362 attached to the flange 236 and configured to cover at least a portion of the acoustic opening 542. In various embodiments, the dome 1362 can be formed integrally with the flange 236. Alternatively, the dome 1362 may be formed separately from the flange 236 and subsequently joined to the flange using any suitable means such as adhesives or the like.

In various embodiments, the dome 1362 is connected to the flange 236 such that the outer perimeter of the dome 1362 is flush with the outer perimeter 1262 of the flange. Such a configuration creates a smooth boundary between the dome 1362 and flange 236 enhancing user comfort. Moreover, the profile of the dome 1362 provides a smooth shape with minimal ledges, reducing the number of surfaces that foreign material may become trapped in.

In various embodiments, the dome 1362 is configured to cover the acoustic opening 542. The dome can include one or more dome openings 1364 that are in acoustic communication with the acoustic opening 542. The dome openings 1364 are configured to be sufficiently large such that sounds generated at the receiver 212 can propagate through the dome openings 1364 into the ear canal of a wearer, but small enough to reduce the likelihood of foreign material from entering the ear-wearable device 200 via the dome openings 1364. For instance, in embodiments where the acoustic opening 542 has a diameter DA of approximately 1 mm, the dome openings 1364 may each have a diameter of between about 0.2 mm and 0.75 mm. The dome 1362 can include any suitable number of dome openings 1364. In some embodiments, the number of dome openings 1364 can be greater than or equal to 1, 4, or 6 dome openings, or can be an amount falling within a range between any of the foregoing.

The dome 1362 can be formed from any suitable material or materials including, but not limited to fluorelastomeric materials such as Viton™ fluoroelastomer materials, rubbers such as neoprene, silicone, other ductile polymers, or the like. In various embodiments, dome 1362 can be formed from a complaint material to enhance user comfort when the ear-wearable device 200 is placed in the ear. In various embodiments, dome 1362 can be formed from the same material or materials as the acoustic tube 232. Alternatively, the dome 1362 can be formed from different materials than the acoustic tube 232.

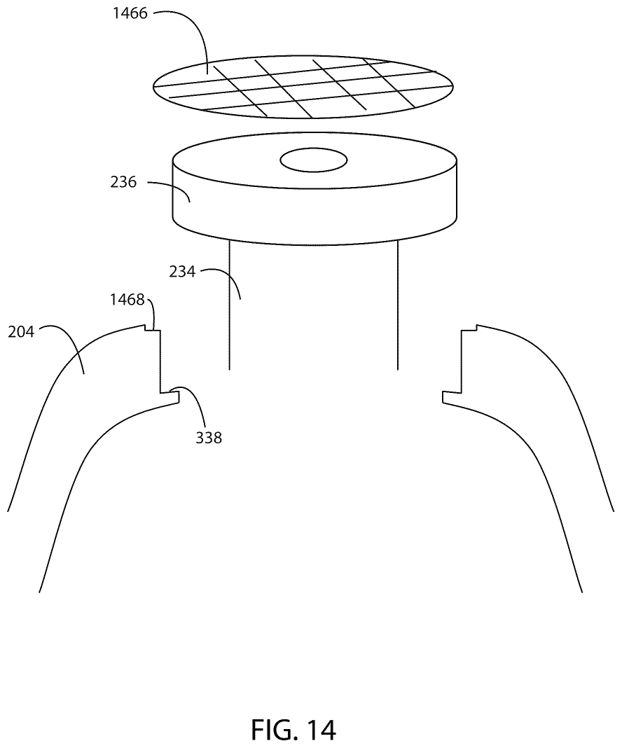

Referring now to FIG. 14, an exploded perspective view of an acoustic tube having a mesh layer is shown in accordance with various embodiments herein. In various embodiments, the acoustic tube can include a stem 234, a flange 236 and an acoustic opening 542 through the flange and stem. The acoustic tube 232 can further include a mesh layer 1466 configured to cover at least a portion of the acoustic opening 542.

In various embodiments, the mesh layer 1466 is configured to cover the acoustic opening 542. The mesh layer can include a mesh that is adequately dense to reduce the likelihood of foreign material from entering the ear-wearable device 200 via the acoustic opening 542, but not too dense as to diminish the sound generated at the receiver 212 from propagating through the mesh layer and into the ear canal of a wearer.

In various embodiments, the mesh layer 1466 is configured to rest on top of the flange 236 when installed in an ear-wearable device 200. It is desirable that the mesh layer does not contact the flange 236 as to preserve the ability of the flange 236 to absorb the vibrations generated at the receiver 212. In the example of FIG. 14, the shell 204 of ear-wearable device 200 has a first ledge 338 and a second ledge 1468 defined around the first shell opening 223. When in an assembled state, the flange 236 of acoustic tube 232 is configured to rest on the ledge 338 and the mesh layer 1466 is configured to rest on the second ledge 1468. The second ledge 1468 can be spaced apart from the first ledge 338 such that mesh layer 1466 does not contact the flange 236.

In various embodiments, the mesh layer 1466 can have approximately the same diameter as the flange 236. The mesh layer 1466 can be any suitable acoustic mesh. The mesh layer 1466 can be any suitable material or materials that is permeable to gases and reduces the transmission of solids and liquids. In some embodiments, the mesh layer can be a very fine mesh. Examples of appropriate mesh layers are sold by Saati S.p.A. of Vilano, Italy, under the tradename Acoustex, including SAATI Nanomesh AETHEX™ material or the like.

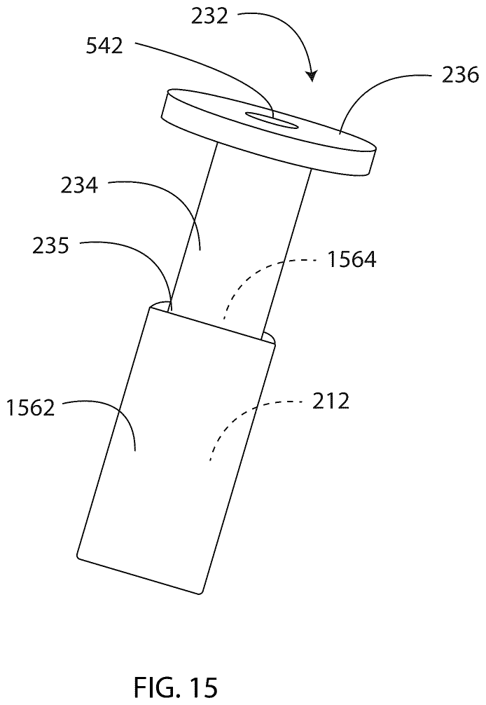

### Acoustic Tube and Receiver Housing (FIG. 15)

Referring now to FIG. 15, a perspective view of an alternative configuration of an acoustic tube is shown in accordance with various embodiments herein. In various embodiments, the acoustic tube can include a stem 234, a flange 236 and an acoustic opening 542 through the flange and stem. In the example of FIG. 15, the first end 235 of the stem 234 is fixedly attached to a receiver housing 1562. In various embodiments, the receiver housing 1562 is configured to suspend the receiver 212 within the shell cavity 208 when the acoustic tube 232 is installed in an ear-wearable device 200.

In various embodiments, the receiver housing 1562 can have a housing outlet 1564 that is acoustic communication with the acoustic opening 542 such that sounds generated by the receiver 212 can propagate through the acoustic tube 232 and exit the ear-wearable device 200 through the first shell opening 223 when the acoustic tube 232 is installed in an ear-wearable device.

In various embodiments, the receiver housing 1562 can be formed integrally with the acoustic tube 232. Alternatively, the receiver housing 1562 may be formed separately from the acoustic tube 232 and subsequently joined using any suitable means such as adhesives or the like.

The receiver housing 1562 can be formed from any suitable material or materials including, but not limited to fluorelastomeric materials such as Viton™ fluoroelastomer materials, rubbers such as neoprene, silicone, other ductile polymers, or the like. In various embodiments, the receiver housing 1562 can be formed from the same material or materials as the acoustic tube 232. Alternatively, the receiver housing 1562 can be formed from different materials than the acoustic tube 232.

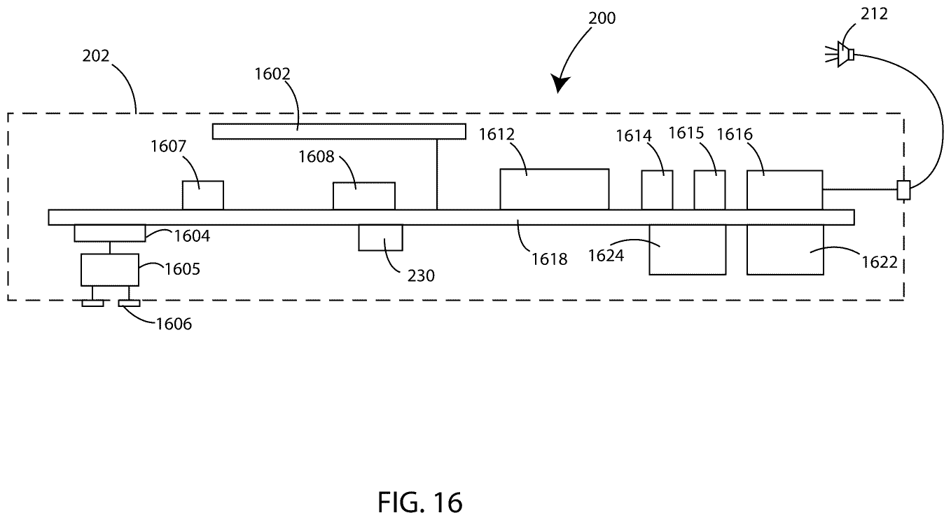

### Schematic of Internal Components of Ear-Wearable Device (FIG. 16)

Referring now to FIG. 16, a schematic block diagram is shown with various components of an ear-wearable device 200 in accordance with various embodiments. These components are enclosed within the housing 202 of the ear-wearable device with is formed by the faceplate and the test shell. The block diagram of FIG. 16 represents a generic ear-wearable device for purposes of illustration. The ear-wearable device 200 shown in FIG. 16 includes several components electrically connected to a circuit board 1618 (e.g., flexible circuit board) which is disposed within housing 202. A power supply circuit 1604 can include a battery 1605, can be electrically connected to the circuit board 1618, and provides power to the various components of the ear-wearable device 200. In some embodiments, one or more charging contacts 1606 are connected to the battery 1605 and are configured to interface with the charging contacts of the charging case. In other embodiments, the charting contacts are not present and the battery 1605 is replaced when exhausted.

One or more microphones 1607 are electrically connected to the circuit board 1618, which provides electrical communication between the microphones 1607 and a digital signal processor (DSP) 1612. Among other components, the DSP 1612 incorporates or is coupled to audio signal processing circuitry configured to implement various functions described herein. One or more user input devices 230 (e.g., on/off, volume, mic directional settings) are electrically coupled to the DSP 1612 via the circuit board 1618.

A sensor package 1614 can be coupled to the DSP 1612 via the circuit board 1618. The sensor package 1614 can include one or more different specific types of sensors. The ear-wearable device includes an ear-wearable device IMU 1615. The IMU 1615 is configured to detect a vibration sequence as a part of a pairing method for the wireless communication device 1608, among other useful data that can be ascertained from IMU 1615.

As used herein the term “inertial measurement unit” or “IMU” shall refer to an electronic device that can generate signals related to a body's specific force and/or angular rate. IMUs herein can include one or more accelerometers (3, 6, or 9 axis) to detect linear acceleration, a gyroscope to detect rotational rate, or both. In some embodiments, in the alternative or in addition, an IMU includes a magnetometer to detect a magnetic field.

An audio output device 1616 is electrically connected to the DSP 1612 via the circuit board 1618. In some embodiments, the audio output device 1616 comprises a speaker (coupled to an amplifier). In other embodiments, the audio output device 1616 comprises an amplifier coupled to a receiver 212 adapted for positioning within an ear of a wearer. The receiver 212 can include an electroacoustic transducer, speaker, or loudspeaker.

The ear-wearable device 200 may incorporate a wireless communication device 1608 coupled to the circuit board 1618 and to an antenna 1602 directly or indirectly via the circuit board 1618. The communication device 1608 can be a high-frequency radio, such as a 2.4 GHz radio. The radio can conform to an IEEE 802.11 (e.g., WiFi®) or a Bluetooth® (e.g., Bluetooth® low energy, Bluetooth® 4. 2 or 5.0, and Bluetooth® Long Range) specification, for example. It is understood that ear-wearable devices of the present disclosure can employ other radios, such as a 900 MHz radio.

Ear-wearable devices of the present disclosure can be configured to receive streaming audio (e.g., digital audio data or files) from an electronic or digital source. Ear-wearable devices herein can also be configured to switch communication schemes to a long-range mode of operation, wherein, for example, one or more signal power outputs may be increased, and data packet transmissions may be slowed or repeated to allow communication to occur over longer distances than that during typical modes of operation. Representative electronic/digital sources (also serving as examples of accessory devices herein) include an assistive listening system, a TV streamer, a radio, a smartphone, a cell phone/entertainment device (CPED), a pendant, wrist-worn device, or other electronic device that serves as a source of digital audio data or files.

The communication device 1608 can be configured to communicate with one or more external devices, such as a wireless communication device of a charging case, a wireless communication device of another ear-wearable device, a wireless communication device of a smart phone, or a wireless communication device of another system, such as other systems discussed herein, in accordance with various embodiments. In various embodiments, the communication device 1608 can be configured to communicate with an external visual display device such as a smart phone, a video display screen, a tablet, a computer, or the like.

In various embodiments, the ear-wearable device 200 can also include a control circuit 1622 and a memory storage device 1624. The control circuit 1622 can be in electrical communication with other components of the device. The control circuit 1622 can execute various operations, such as those described herein. The control circuit 1622 can include various components including, but not limited to, a microprocessor, a microcontroller, an FPGA (field-programmable gate array) processing device, an ASIC (application specific integrated circuit), or the like. The memory storage device 1624 can include both volatile and non-volatile memory. The memory storage device 1624 can include ROM, RAM, flash memory, EEPROM, SSD devices, NAND chips, and the like.

The memory storage device 1624 can be used to store data from sensors as described herein and/or processed data generated using data from sensors as described herein, including, but not limited to, information regarding exercise regimens, performance of the same, visual feedback regarding exercises, and the like.

It is noted that the structure and housing of a second ear-wearable device is not illustrated herein but may be similar to or identical to the first ear-wearable device.

Ear-wearable devices of the present disclosure can incorporate an antenna arrangement coupled to a high-frequency radio, such as a 2.4 GHz radio. The radio can conform to an IEEE 802.11 (e.g., WiFi® standard) or Bluetooth® standard (e.g., BLE, Bluetooth® 4. 2 or 5.0) specification, for example. It is understood that ear-wearable devices of the present disclosure can employ other radios, such as a 900 MHz radio. Ear-wearable devices of the present disclosure can be configured to receive streaming audio (e.g., digital audio data or files) from an electronic or digital source. Representative electronic/digital sources (also referred to herein as accessory devices) include an assistive listening system, a TV streamer, a radio, a smart phone, a cell phone/entertainment device (CPED) or other electronic device that serves as a source of digital audio data or files.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise. It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed, and arranged, constructed, manufactured, and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

The claims:

1. An ear-wearable device comprising:
a shell configured to fit within an ear of a user, the shell comprising:
a shell cavity; and
a shell opening to the shell cavity;
a receiver disposed within the shell cavity;
an acoustic tube, wherein the acoustic tube is configured to connect the receiver to the shell opening such that sounds generated by the receiver exit the ear-wearable device through the shell opening, the acoustic tube comprising:
a stem, the stem comprising:
a first end, wherein the first end is connected to the receiver; and
a second end;
a flange connected to the second end, the flange configured to contact the shell opening along an inner flange surface such that the stem does not contact the shell, wherein the flange comprises a deformable material such that vibrations of the receiver result in deformations of at least a portion of the flange.

2. The ear-wearable device of claim 1, wherein the deformations of the flange reduce transmission of the vibrations from the receiver to the shell.

3. The ear-wearable device of claim 1, wherein the deformable material has a modulus of elasticity can be greater than or equal to 5 megapascals.

4. The ear-wearable device of claim 1, wherein the deformable material comprises a fluoroelastomeric material.

5. The ear-wearable device of claim 1, wherein the shell opening comprises a ledge and the flange is configured to be positioned on the ledge along the inner flange surface.

6. The ear-wearable device of claim 5, wherein the inner flange surface is joined to the ledge using an adhesive.

7. The ear-wearable device of claim 5, the flange further comprising:
a supported portion, wherein the supported portion is in contact with the ledge along the inner flange surface; and
a non-supported portion, wherein the non-supported portion is not in contact with the ledge along the inner flange surface.

8. The ear-wearable device of claim 7, wherein the vibrations of the receiver result in deformations of the non-supported portion.

9. The ear-wearable device of claim 1, wherein the flange is integral with the stem.

10. The ear-wearable device of claim 1, wherein the flange and the stem are formed separately and subsequently joined together.

11. The ear-wearable device of claim 1, further comprising a structure placed over the shell opening, wherein the structure is configured to obstruct debris from passing through the shell opening.

12. The ear-wearable device of claim 11, wherein the structure comprises one of the group consisting of a dome, a bridge, or a mesh.

13. The ear-wearable device of claim 1, the acoustic tube comprising a receiver housing configured to enclose the receiver within the shell cavity.

14. An ear-wearable device comprising:
a shell configured to fit within an ear of a user, the shell comprising:
a shell cavity; and
a shell opening to the shell cavity;
a receiver disposed within the shell cavity;
a receiver housing configured to suspend the receiver within the shell cavity, the receiver housing defining a receiver housing outlet;
an acoustic tube comprising:
a stem, the stem comprising:
a first end, wherein the first end is connected to the receiver housing around the receiver housing outlet; and
a second end disposed at the shell opening;
a flange connected to the second end, the flange configured to contact the shell opening along an inner flange surface such that the stem does not contact the shell;
wherein sounds generated by the receiver propagate from the receiver housing outlet to the shell opening via the acoustic tube; and
wherein the flange comprises a deformable material such that vibrations of the receiver result in deformations of at least a portion of the flange.

15. The ear-wearable device of claim 14, wherein the deformations of the flange reduce transmission of the vibrations from the receiver to the shell.

16. The ear-wearable device of claim 14, wherein the acoustic tube is integral with the receiver housing.

17. The ear-wearable device of claim 14, wherein the shell opening comprises a ledge and the flange is configured to be positioned on the ledge along the inner flange surface.

18. The ear-wearable device of claim 17, the second flange portion further comprising:
a supported portion, wherein the supported portion is in contact with the ledge along the inner flange surface; and
a non-supported portion, wherein the non-supported portion is not in contact with the ledge along the inner flange surface.

19. The ear-wearable device of claim 18, wherein the vibrations of the receiver result in deformations of the non-supported portion.

20. An ear-wearable device comprising:
a shell configured to fit within an ear of a user, the shell comprising:
a shell cavity; and
a shell opening to the shell cavity, wherein the shell opening comprises a ledge;
a receiver disposed within the shell cavity;
an acoustic tube, wherein the acoustic tube is configured to connect the receiver to the shell opening such that sounds generated by the receiver exit the ear-wearable device through the shell opening, the acoustic tube comprising:
a stem, the stem comprising:
a first end, wherein the first end is connected to the receiver; and
a second end;
a flange connected to the second end, the flange configured to be positioned on the ledge along an inner flange surface such that the stem does not contact the shell, the flange comprising:
a supported portion, wherein the supported portion is in contact with the ledge along the inner flange surface; and
a non-supported portion, wherein the non-supported portion is not in contact with the ledge along the inner flange surface.
